(19) United States
(12) Patent Application Publication
(10) Pub. No.: US 2016/0045785 A1
(43) Pub. Date: Feb. 18, 2016

(54) ACTION SPORTS TRACKING SYSTEM AND METHOD

(71) Applicants: Nicolás Tzovanis, Buenos Aires (AR); Guido Marucci Blas, Buenos Aires (AR); Matias Daniel Fineschi, Buenos Aires (AR)

(72) Inventors: Nicolás Tzovanis, Buenos Aires (AR); Guido Marucci Blas, Buenos Aires (AR); Matias Daniel Fineschi, Buenos Aires (AR)

(73) Assignee: BOARD TRACKING TECHNOLOGIES, LLC, San Francisco, CA (US)

(21) Appl. No.: 14/824,864

(22) Filed: Aug. 12, 2015

Related U.S. Application Data
(60) Provisional application No. 62/036,349, filed on Aug. 12, 2014.

(51) Int. Cl. A63B 24/00; H04B 7/26

(52) U.S. Cl. CPC A63B 24/0003; H04B 7/26

(57) ABSTRACT

An action sports tracking platform, including systems and devices, and related methods of tracking action sports movements are disclosed. Embodiments of the invention consist of an electronic tracking device attached to a sporting device, such as a board, which interacts with a mobile device that runs an application and algorithm for detection of sport action(s) involving the sport device in real time. Users have access to a social network or platform where they can share their tricks, scores, location, follow skaters, and play online games. In addition, performed sport actions can be rendered for display and sharing, and even comparison with previously stored comparable sport actions.

### CROSS-REFERENCE TO RELATED APPLICATIONS

This disclosure is a non-provisional application that claims the benefit of U.S. Provisional Patent Application No. 62/036,349, filed Aug. 12, 2014, under 35 U.S.C. §119(e), and is incorporated herein by reference in its entirety for all purposes.

### BACKGROUND

1. Field of the Disclosure

The present invention is in the technical field of electronics and computing technology applied to sport activities and social networks. More particularly, the present invention is in the technical field of tracking devices for tracking movement of sport devices used in sports activities.

2. Background

Recently there have been many attempts to create applications and devices for tracking progress in the performance of various sports. This particular technology aims to provide those who practice sports a way to record and analyze their performance. Many of these devices are just mobile applications that record data, generate statistics and show them in a visual and user-friendly interface. Most of those applications make use of the mobile device's Global Positioning System (GPS) components or its integrated inertial sensors to gather data. The main disadvantage of such devices and applications is that they depend completely on the mobile device to work. Applications that require extra hardware or special sensors are typically limited to sports like golf or running.

### BRIEF SUMMARY

The present invention is a platform based on a tracking device for sports integrated with a social network background. The electronics tracking device tracks the movement of a sporting device during a performance of a sporting action involving the sporting device in real time, and users can share their performances, scores, and locations over the Internet via a social network. While board related embodiments, such as skateboard, surfboard and snowboard, are used throughout this disclosure, the system and method are not limited to those embodiments, as one skilled in the art could understand.

In one aspect, a sport tracking system is disclosed. In one exemplary embodiment, such a sport tracking system may comprise at least one tracking device, where each such device includes a mounting subsystem for attaching the tracking device to a sport device, and a plurality of motion sensors configured to capture a sport action event involving the sport device. In addition, such a tracking device may further include a processor to create a data stream comprising the captured sport action, a memory module for local storage of the data stream, and a communication module configured to transmit the data stream. Further, such devices may also include a power source module, and a tracking device case to protect the tracking device. Uniquely, such a system may further include a mobile application, executable on a mobile device, to render graphic images or graphic video of the sport action from the transmitted data stream to a user of the mobile device.

In another aspect, methods of tracking a sport action event involving a sport device are also disclosed. In an exemplary embodiment, such a method may comprise capturing motion data of a sport device during a sport action using a plurality of motion sensors housed within a tracking device attached to a sport device, and creating a data stream comprising the sport action from the captured motion data using a processor housed within the tracking device. Such a method may further include storing the data stream in a memory module housed within the tracking device, and transmitting the data stream from tracking device to an application, executed on a computing device, using a communication module housed in the tracking device. Still further, such a method may also include reading the data stream received at the computing device with the application, and generating a 3D graphic image or graphic video of the sport action from the data stream using the application, the generated 3D graphic image or graphic video displayable on the computing device.

### BRIEF DESCRIPTION OF THE DRAWINGS

For a more complete understanding of the present invention and its advantages, reference is now made to the following description and the accompanying drawings, in which:

FIG. 1 presents a diagram of the modules of the platform in accordance with the disclosed principles.

FIG. 2 is a perspective view of the tracking device in accordance with the disclosed principles attached to a skateboard.

FIG. 3 is a close up, perspective view of a tracking device in accordance with the disclosed principles.

FIG. 4 is a perspective, exploded view of the tracking device of FIG. 3.

FIG. 5 is a left view of a tracking device in accordance with the disclosed principles attached to a skateboard.

FIG. 6 is a block diagram of the components comprising a tracking device in accordance with the disclosed principles.

FIG. 7 is a flow diagram for method of trick detection in accordance with the disclosed principles.

FIG. 8 represents a schematic view of an Options screen of a mobile application in accordance with the disclosed principles.

FIG. 9 represents a schematic view of a Skater's Profile in the mobile application of FIG. 8.

FIGS. 10-12 illustrate various images of another embodiment of a tracking device in accordance with the disclosed principles.

FIGS. 13-14 illustrates an embodiment of a tracking device in accordance with the disclosed principles in relation to skateboard truck.

FIGS. 15-16 illustrates the tracking device of FIGS. 13-14 mounted on a skateboard between the deck and a truck.

FIGS. 17-17A illustrates screen shots of a home page of a mobile application in accordance with the disclosed principles and for use with a tracking device as disclosed herein.

FIGS. 18-18A illustrate screen shots of the mobile application presenting the location and details of trick performed and captured with a tracking device in accordance with the disclosed principles.

FIGS. 19-19B illustrate screen shots of the mobile application of the disclosed principles as used to record a session of one or more tricks, including the location of each trick performed.

FIGS. 20-20A illustrate screen shots of the mobile application presenting a 3D rendering of a user's skateboard during the performance of a trick and captured using a tracking device in accordance with the disclosed principles.

FIGS. 21-21A illustrate screen shots of the mobile application in both the disconnected and connected states with a tracking device in accordance with the disclosed principles.

FIG. 22 illustrate a screen shots of the mobile application where the application may be used to share via the internet information captured with the application and a tracking device in accordance with the disclosed principles.

### DETAILED DESCRIPTION

We refer to a platform as a system integrated of several subsystems (such as sensors, data storage or memories, communications devices, routers, etc.) which interact together with a common purpose. Adding subsystems to the platform may create new features or improve its functionality.

### System Overview

Around 4 million skateboarding videos are currently posted on YouTube®. Skaters love watching them because they are both enjoyable and educational, as well as inspiring. Editing videos is not an easy thing, however. Selecting, downloading and editing pro-style videos that appear professionally created and accurately capture performances takes time and know-how. But all of those short comings are addressed by a device and related method in accordance with the disclosed principles.

The disclosed principle provide the first device that allows skateboarders to easily shoot and edit their own action sports videos, while also tracking the specific movement (and location) of the board being used. It also allows board-based athletes, such as skaters, surfers, etc., to track their sessions by creating 3Drenderings to replay real board movements, something that has never been done before. Additionally, the scalability of this novel rendering technology is advantageous in view of prior attempts and devices.

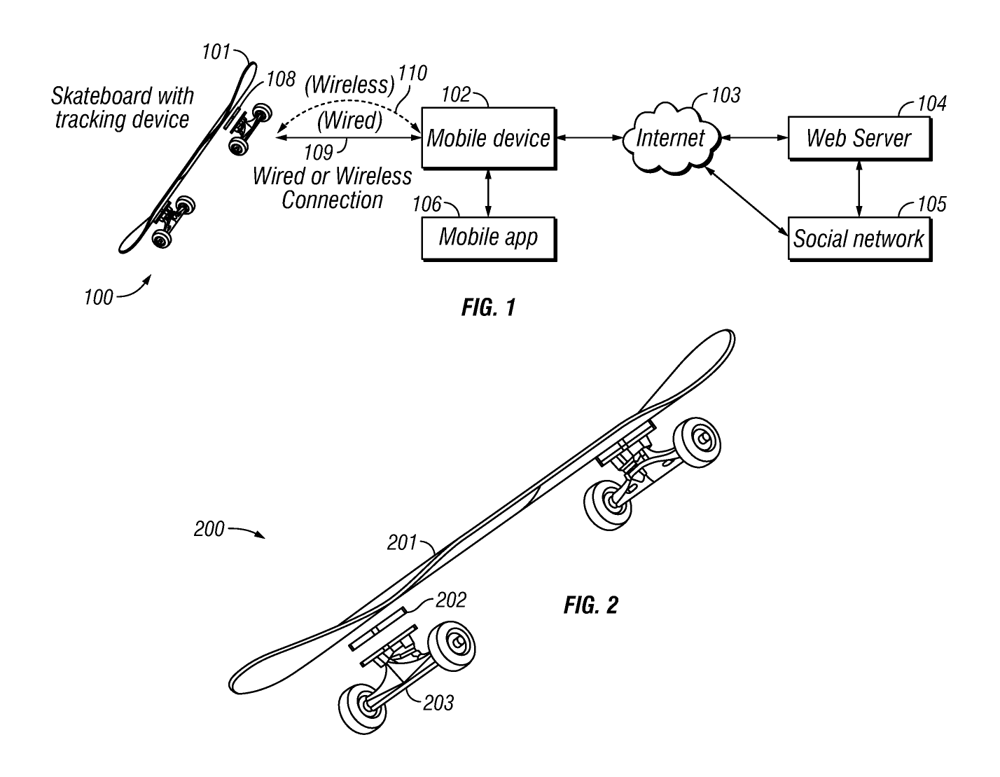

FIG. 1 illustrates a diagram of the modules included in a tracking platform 100 for board, action, extreme or other repetitive motion sports 101, for example, skateboarding, snowboarding, biking, surfing, kitesurfing, sandboarding, parachuting, windsurfing, paddle boarding, baseball, hockey etc. The motion detection is captured by a tracking device 108 attached to the user or to the sporting device 101 in use by the user. The tracking device 108 senses the movements of the board 101 and sends the information to a mobile device 102, for example, a mobile phone, a personal digital assistant (PDA), a laptop, etc. The movements of the board 101 can also be stored locally on the tracking device 108 via local memory storage or removable computer storage media.

The information may be sent to the mobile device 102 using a wired interface 109, such as USB, or through a wireless interface 110, such as Bluetooth®. The interfaces 109/110, can receive the information in a real-time manner or at a specific time, based on user preferences. If the information is sent to the mobile device 102 from the wired interface 109 or wireless interface 110 at a later time the information can be retrieved from the local memory or removable computer storage media.

The mobile device 102, using a combination of the tracking device 108 and a software-based application 106 making use of a sport action (or “trick”) detection algorithm that recognizes which trick was performed by the user using artificial intelligence (Al), machine learning algorithms (ML), or other similar technology. The trick detection algorithm allows the software-based application 106 to generate statistics, render 3D trick diagrams and 3D graphic videos based on the performed recognized trick.

The processing system may be embedded on the mobile device 102, or a distributed architecture via a network connection 103 for processing. The network connection 103 can allow for the remote storage of the information in a distributed web server 104 architecture. The mobile device 102 can use any form of wired or wireless connection method to connect to the network connection 103.

The mobile device 102 runs an application 106 that receives data from the tracking device 108 and may also be synchronized with a social network 105. The data received by the application 106, can come from the wired interface 109 or the wireless interface 110. The data can be transmitted by the tracking device 108 in real-time manner or at a later time, from the local memory or the removable computer storage media. The application 106 can connect to the social network via the network connection 103. In one embodiment the application 106 transmits the data via the network connection 103 to the application web server 104, which then transmits the data to the social network 105. In an alternative embodiment the application 106 can send the data directly to the social network 105 via the social network's webserver and the network connection 103.

Each detected trick may be scored based on certain parameters of elements of each trick as compared to other tricks previously recorded or the success of which is otherwise predetermined and stored for access by the application 106. The previously recorded tricks can be retrieved from the local memory, removable computer storage media, or remote web server 104 storage. The scoring of each detected trick can be performed by the application 106 or through a network connection 103 and distributed web server based architecture. The tricks detected by the tracking device 108 and mobile device 102 can be shared with other members via a proprietary social network 105 or on other social networks, for example, Facebook®, Instagram® or Twitter®.

In a skateboard embodiment 200 shown in FIG. 2, the disclosed principles provide for a tracking device 202 that resembles a riser pad under a truck 203, but features the latest in motion-sensing and wireless low-power technologies. The motion-sensing technologies allow for tricks to be recorded in a three dimensional manner, while the wireless low-power technologies allow for the connection of the tracking device 202 to the mobile device. From the mobile device the data gathered by the motion-sensing technologies of the tracking device 202 can be processed locally by the mobile application, or transmitted through the wireless low power technologies to a distributed network for processing.

At only 1 mm thick, skaters, in this embodiment of a tracking device as disclosed herein, will never notice it's there. It won't affect how the board 201 feels or handles since the tracking device 202 simply attaches to the board as would a regular riser or cloud. With minimal effect on the board 201 a user can perform tricks with the tracking device 202 attached or replaced by a regular riser pad, without noticing a difference.

Then the tracking device 202 may be paired with a mobile application to capture details and location of tricks that are performed. In addition to the ability to store trick details on local memory or removable computer storage media, for later pairing with the mobile application. Complex algorithms running on the core of the device or on a distributed web servers to recognize when a skater performs a trick. The complex algorithms include artificial intelligence (Al), machine learning algorithms (ML), or other similar technologies. The algorithms can learn the trick from the users' performance, from professional or expert performances of tricks, or from other mobile application users. The algorithms can pull these comparison performances from the local memory, removable computer storage media or remotely on a web server.

In one embodiment, the tracking device 202 notifies the application at the exact moment you perform a trick, and a variety of data is captured by the disclosed tracking device's motion sensors. This variety of data is then fed into the complex algorithms for analysis of the trick parameters and metrics. The activation of the tracking device 202 also triggers the recording feature, creating a rendering of 3D graphic images and/or graphic videos of the trick, and once the trick is completed for the recording to stop. This allows the application to trigger a slow-motion effect and automatically trim the rendering to match your trick. Data gathered by the sensors is processed by the application, which analyzes and scores the trick, as well as creates 3D renderings of the tricks while adding statistics associated with the tricks. The 3D renderings are used to show a user the exact motions of the board during a trick. This can help those learning a new trick perfect their technique and performance. These renderings can be images, graphic videos or any combination thereof.

A user can also select a specific trick (a common trick, a user defined trick, a trick posted on social media or a professional trick) to practice, with specific elements surrounding the area where the user is training. In this mode the user can repeat the specific trick with the mobile application alerting the user to their successful or unsuccessful performance after the trick is analyzed by the complex algorithms. This can even be done by illustrating to the user specific elements of the trick (such as board positioning during a certain part of the trick) that did or did not match the specific trick selected to attempt.

### Tracking Device

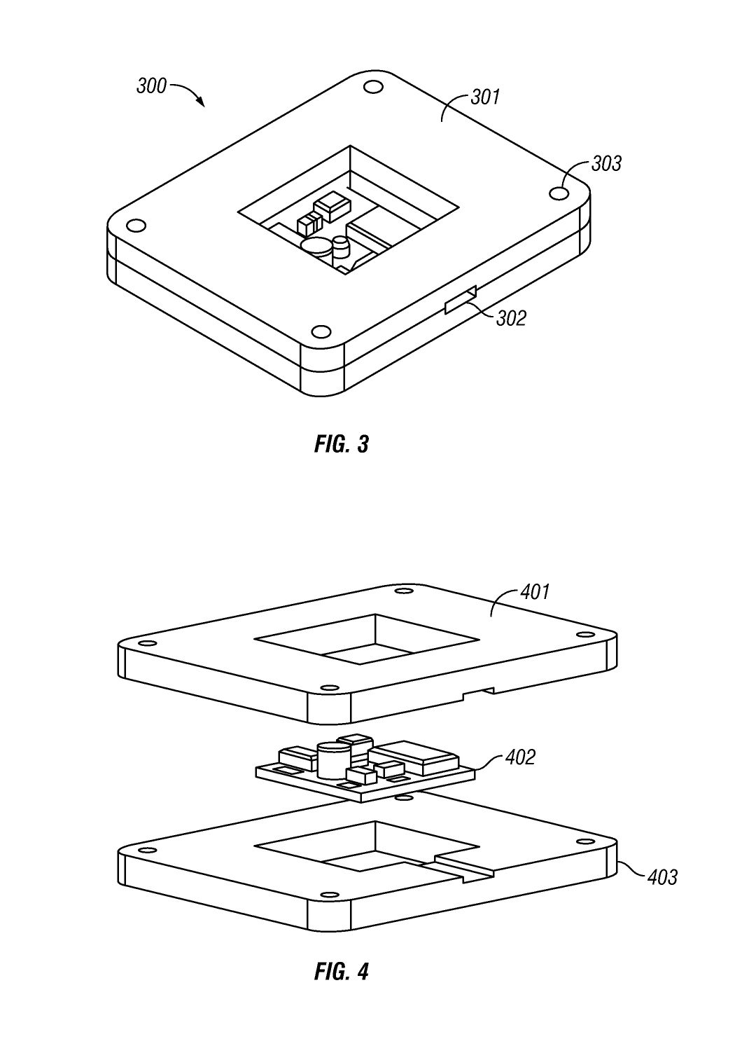

The tracking device consists of an electronic circuit which takes measurements of the inertial variables of the sporting device it is attached to. This tracking device may be attached to any type of board or other sport related device to track performances of most of the actual sports. For example, FIG. 3 and FIG. 4 show a perspective view of a tracking device 300 for a skateboard consisting of a board mounted apparatus comprising a Printed Circuit Board (PCB) circuit 402, the mounting pad 301 (created with two sections 401 and 403), screw holes 303 to mount the tracking device 300 to the board, the Micro USB port connector 302, the ON/OFF switch (not shown), and the led indicator (not shown).

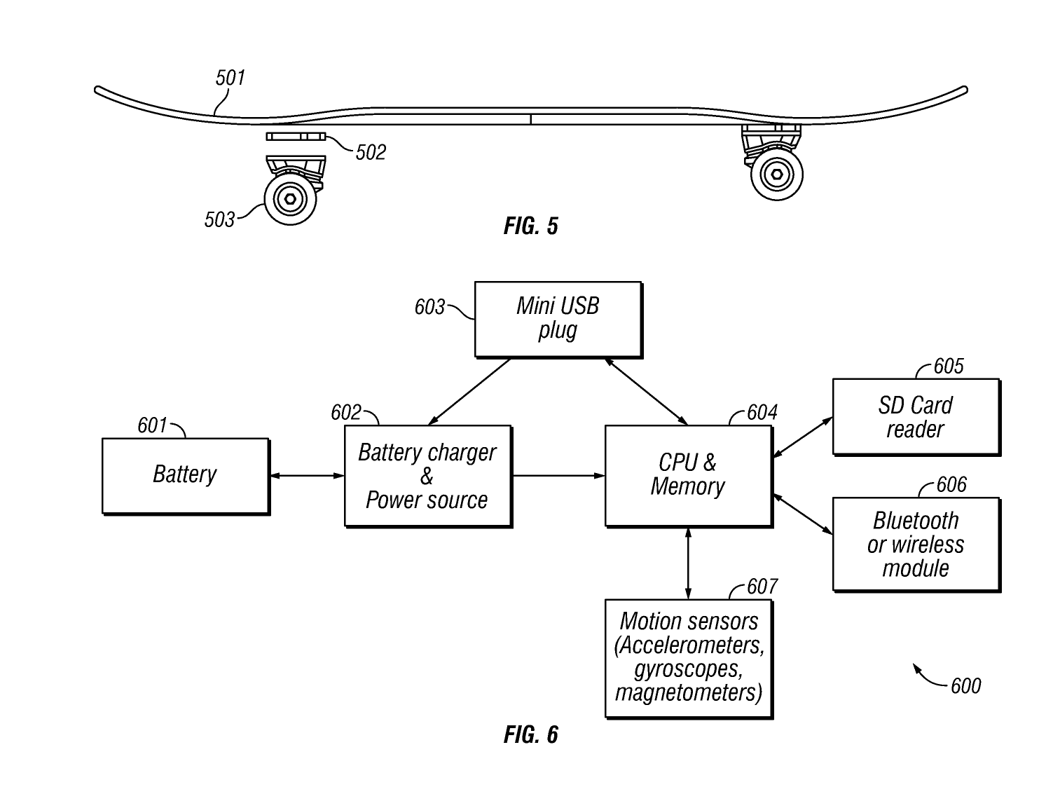

As shown in FIG. 5 the mounting pad 301/502 is designed to fit between the skateboard 501 and the trucks 503 customarily occupied by a regular pad. Still referring to the invention of FIG. 3, the mounting pad 301 is sufficiently rigid and strong to withstand the pressure of the screws and the harsh conditions of skateboarding. The mounting pad 301 also contains a designated space for the attachment of the PCB circuit 402. The PCB circuit 402 is mounted on the designated space and using, for example, screws or even adhesives like glue to avoid excessive vibrations. Excessive vibrations are undesired because of the sensitive nature of the motion sensors used by the tracking device 300. A cushioning system is also utilized between the mounting pad surface and the PCB circuit in order to deaden the vibrations produced by the board's 501 movement.

The PCB circuit 402 is an electronic circuit 600, such as the one seen in FIG. 6, and may comprise a microprocessor and a memory 604, a Bluetooth or wireless module 606, an accelerometer, a gyroscope, and a magnetometer (or other advantageous motion capture sensors) module 607, an SD card reader 605, a battery charger and power source module 602. A mini USB plug 603 also allows for updating the tracking device microprocessor and memory 604, and charging the battery 601. The electronic device 600 may also include a GPS system for storing the location of where a trick or a series of tricks were performed. The date and time of a trick may also be detected and stored.

The electronic circuit 600 may include at least one central processing unit (CPU) 604. For example, the CPU 604 may represent one or more microprocessors, and the microprocessors may be “general purpose” microprocessors, or a combination of general and special purpose microprocessors. Additional specialized processing resources such as graphics, multimedia, or mathematical processing capabilities, either in hardware or in software, may also be used as adjuncts or replacements for processors for certain processing tasks.

The electronic circuit 600 also consists of a 3-axis magnetometer, a 3-axis gyroscope and a 3-axis accelerometer. The combination of the 3 sensors form an inertial measurement unit (IMU) 607 that can report the velocity, orientation and gravitational forces applied to the mounting pad 301, and hence, of the board 501. Of course, the IMU may also include other types of sensors configured to capture the information useable by a device or system as disclosed herein. The IMU 607 is what provides the complex algorithms with data to perform analysis and render 3D video of the board motions. The magnetometer is included so that yaw drift can be corrected. The data provided by the sensors may be processed by the CPU, which may apply filters to smoothen the signals such as Finite Impulse Response (FIR) or Infinite Impulse Response (IIR) digital filters.

The CPU 604 may also calculate the pitch, yaw, and roll angles of the mounting pad 301 before sending this information to the mobile device in a data stream. This may be done in order to speed performance of processing or video rendering by the mobile application or remote web server processing. In case the connection with the mobile device is lost, the CPU 604 may also store the information provided by the sensors in the local memory or removable computer storage media. When the connection is restored the CPU 604 can send the stored information to the mobile device, via the wireless module 606 or the mini USB plug 603.

The information provided by the sensors may transmitted to the mobile device through a wired or a wireless connection. A wireless connection module 606 may include, but it is not limited to, a Bluetooth® connection or a ZigBee® connection, a Near Field Communication (NFC) connection, a WIFI connection or other wireless short range data connection. A wired connection may be a USB, a Thunderbolt, a RS232 connection or such 603. This connection module 606 can also allow a user to update the tracking device and program personal information such as identification information, or personal style information directly to the tracking device.

The power source module 601 provides the energy for the whole device. The power source module 601 also charges the internal battery when connected to an external power source. The external power source can be a wired connection 603, a solar cell connection, a motion generated power source or inductive (touch/wireless) charging.

A tracking device as disclosed herein may also be waterproof in case of use for a watersports such as windsurfing, wakeboarding, surf, etc. The electronic device 600 would be sealed within the mounting pad 301.

### Detecting Algorithm

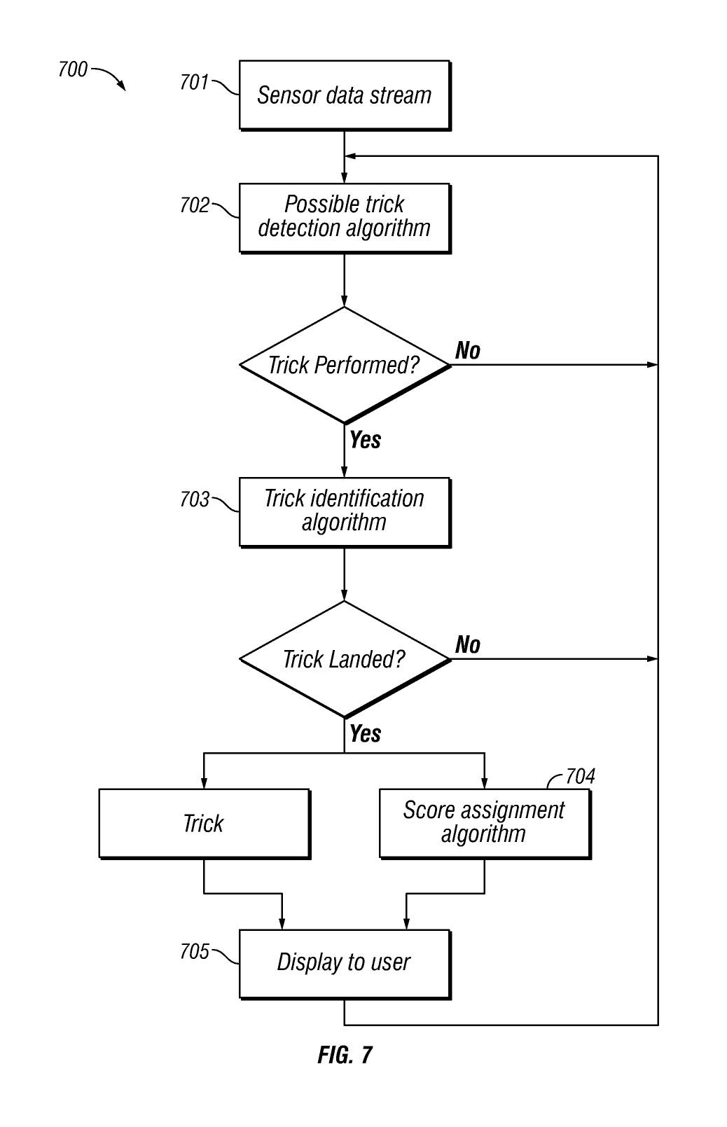

The flow diagram illustrated in FIG. 7 shows a method based on some stages or sub-algorithms which take place in the trick identification 703 and scoring assignment 704. These stages may not be performed by the same processing unit. Instead they may be distributed between the CPU in the tracking device, the mobile device or even a distributed architecture. The steps can be performed simultaneously or in a sequenced operation.

As shown in FIG. 7 the first stage of the trick detection process 700 is the isolation of trick candidates among the data stream 701 generated by the sensors. Based on the output signal data stream from the sensors 701, the possible trick detection algorithm 702 identifies when a possible trick has taken place. This detection may be performed by calculating a threshold on the slope of the output curves. It may also be combined with other similar techniques such as detecting an abrupt change on the tendency of the curves or even use more advanced mathematics such as wavelet integrals. The possible trick detection algorithm 702 can break the data stream 701 into separate trick sections to be further analyzed. The possible trick detection algorithm 702 can also adjust the trick sections as it processes ongoing data stream event in real time or post-run analysis based on user preferences.

Once a trick candidate is detected by the possible trick detection algorithm 702 in the data stream 701, the possible trick detection algorithm 702 must frame the signals into a pattern time frame to be characterized. Based on a prior study of tricks, the longest time frame in which a trick takes place is calculated. This time window is then used to frame all the trick candidates. The time window allows the possible trick detection algorithm 702 to split a multitude of different tricks into separate trick frames, in order to determine if the trick was landed. This is important so the trick identification algorithm 703 processes all the signal with the same time base. This can assist if the tracking device is also linked to an external camera for recording live action. In which case the camera video can have the same time stamp as the trick detection.

The framed signals are then fed to the trick identification algorithm 703 to characterize the tricks. The output of the trick identification algorithm 703 shows which trick has been performed. The trick identification algorithm 703 also reveals if the trick was not landed properly or if the signal does not correspond to a trick. This trick identification algorithm 703 may be based on any Artificial Intelligence (Al) algorithm such as neural network, Support Vector Machine (SVM) or Machine Learning (ML). The trick identification algorithm 703 may also analyze the trick based on a trick profile created by an expert or professional in the sport performing the trick.

Once there has been a landed trick, a score assignment algorithm 704 is run to assign a score based on parameters such as type of trick, air-time, smoothness, quality, etc. The score assignment algorithm 704 can score the trick against friends, a stored trick profile, or against a list of expert or professionally landed tricks. Difficulty of the trick and the location may also be taken into account for the full trick score. The processing time of the whole score assignment algorithm 704 may take in the order of the tens of seconds in order to track the tricks in real time. Thus the user may save, post or share tricks as they performs them.

After the score assignment algorithm 704 has analyzed the trick, the trick score and trick metrics are displayed to the user via a user display interface 705. The user display interface 705 is a learning interface that takes a user's preferences to display the user desired trick metrics and score ratings. In addition the user display interface 705 can also allow the user to save, share the trick to social media or delete the trick.

### Social Network

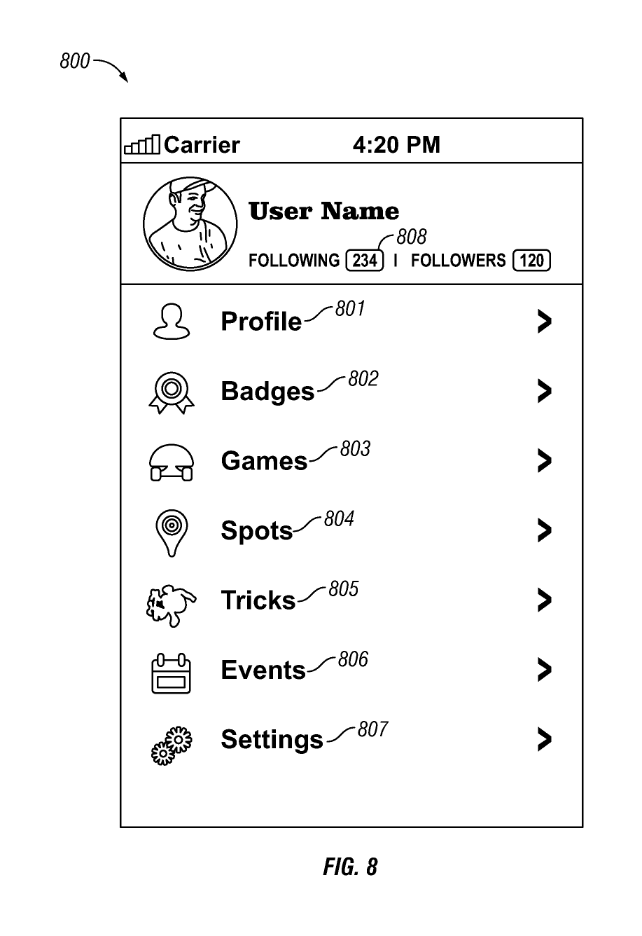

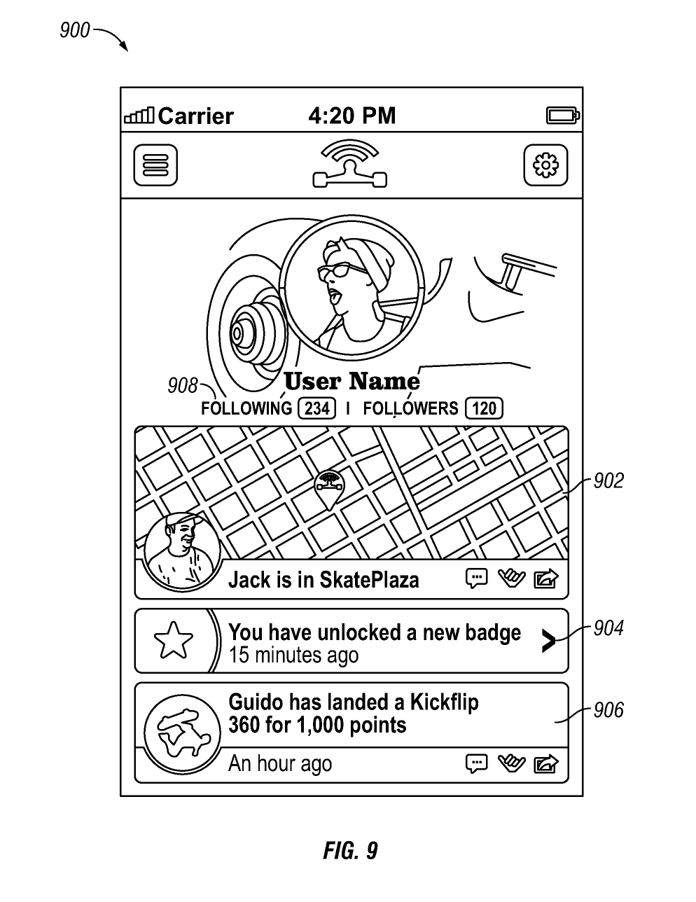

The social network is an Internet based application that may be accessed by either a mobile device, a personal computer or a Personal Digital Assistant (PDA) or other internet connected devices. The main objective may be to connect people that practice board sports. FIGS. 8 and 9 illustrate the social network aspect of the mobile application. The mobile application has a user interface much like a social network. Users of the mobile application are able, but not limited to, creating profiles 800/900 to meet friends and other users. Using the “share” function of an application created in accordance with the disclosed principles, users may post 902 or otherwise share their tricks 906/805, trick's scores 906/805, locations where they performed tricks 904/804, etc., as well as follow other users 808/908 and the history of tricks they perform. The mobile application would also allow members to generate trick challenges or games 803 among friends or followers, and pull tricks from other users that they can store in their trick detection algorithm 703 database.

A user's profile screen 800, allows a member to modify their profile 801, see their badges 802, play or see recently played games 803, their spots or locations 804, tricks they have performed or want to perform 805, events they are planning to go to or have attended 806 and their user settings 807. The user profile screen 800 is not limited to these sections as these are just representative of one embodiment. The games section 803 may include games specific to upcoming events as displayed under the event tab 806, or could be user generated games based on trick scores. The badges tab 802 could include application badges generated based on trick scores, tricks performed or other parameters as a manner of rewarding users for performance and use. A user may want to return to or share their favorite spot for performing tricks which can be done from the spots tab 804. The tricks tab 805 allows the user to maintain a list of currently performed tricks or document previously attempted trick in addition to a list of tricks that the user would like to attempt someday. The user's personal preferences and privacy settings can be modified under the settings tab 807. As with any social network or mobile applications, privacy settings are a critical issue, who may see posts, games, challenges and tricks can be edited via the settings tab 807.

### Mobile Application

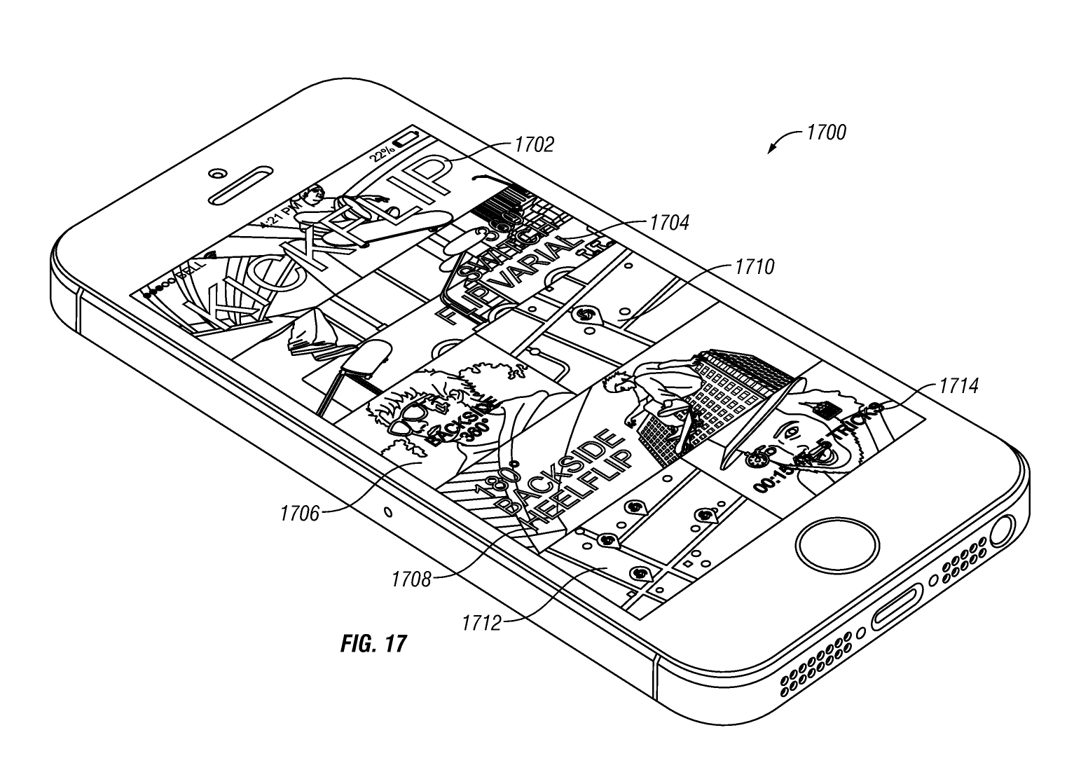

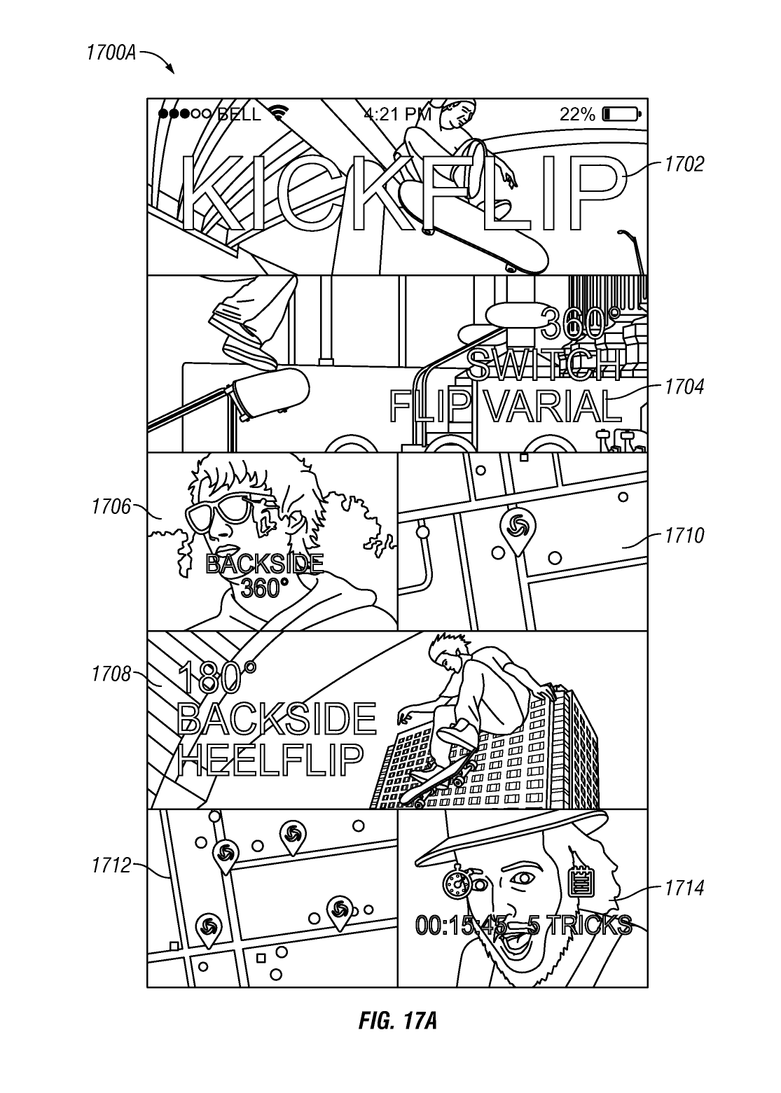

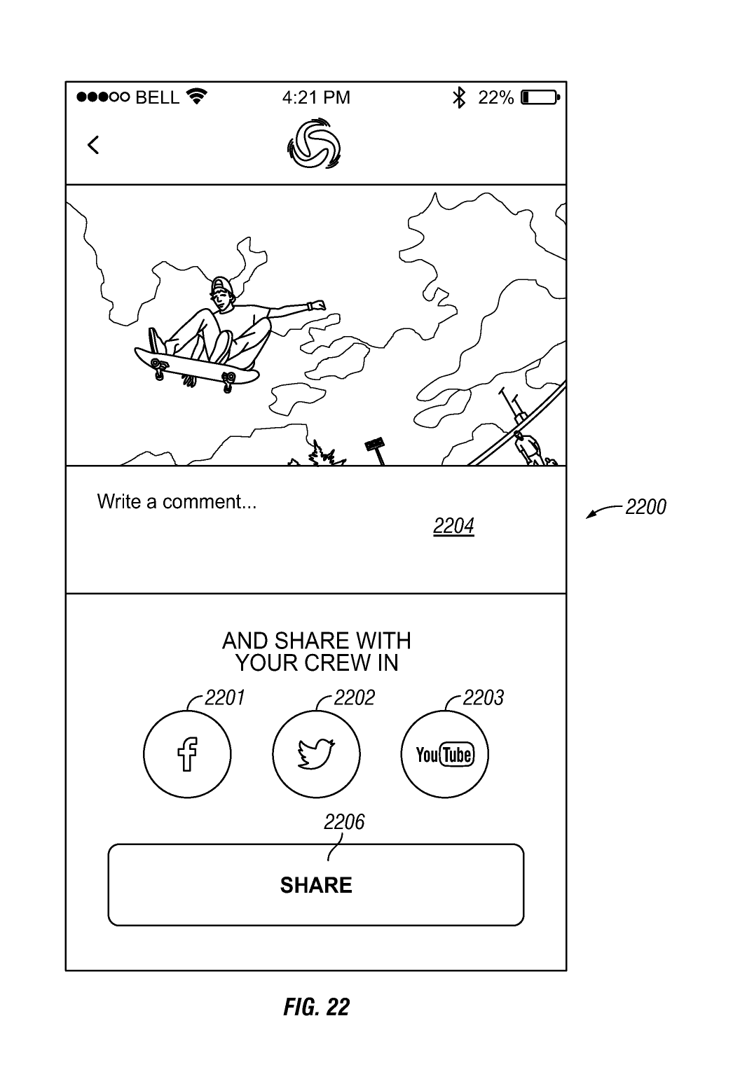

The mobile application 106 may consist, but is not limited to, a connection interface with the tracking device 108, a detection algorithm, a social network interaction interface and a signal processing algorithm. The mobile application 106 may be a native application of the operating system of the mobile device, a downloaded and installed application, or a web application, or a combination thereof. The data stream from the tracking device 108 is received by the mobile application 106. With the data received the mobile application 106 may process it, and generate extra data and display the data to the user. This extra data may be shown to the user graphically or by sound through a speaker. In such embodiments, then it is the final user who decides what to do with that extra data, options may be: discard, save, share through the application linked social network or through other existing social networks. FIGS. 17-22 show various examples of application screen shots when executed on a mobile device, such as a mobile telephone.

FIGS. 17 and 17A illustrate screen shots of a homepage for interaction with the mobile application 106. 1700 is a view of the application running on a device and 1700A is the splash screen running on the device in 1700. In this embodiment, a user has performed a series of tricks recently at various locations. Four of the tricks are shown a “kickflip” 1702, a “360 switch flip varial” 1704, a “backside 360” 1706, and a “180 backside heelflip” 1708. The tricks to be displayed on the homepage can be set as part of their preferences by the user. In addition the user can set the sharing of location information related to where those trick were last performed 1710 or all the locations 1712 where an individual trick was performed. The last recorded session can also be displayed 1714, letting the user quickly see how long they recorded for and how many tricks were performed.

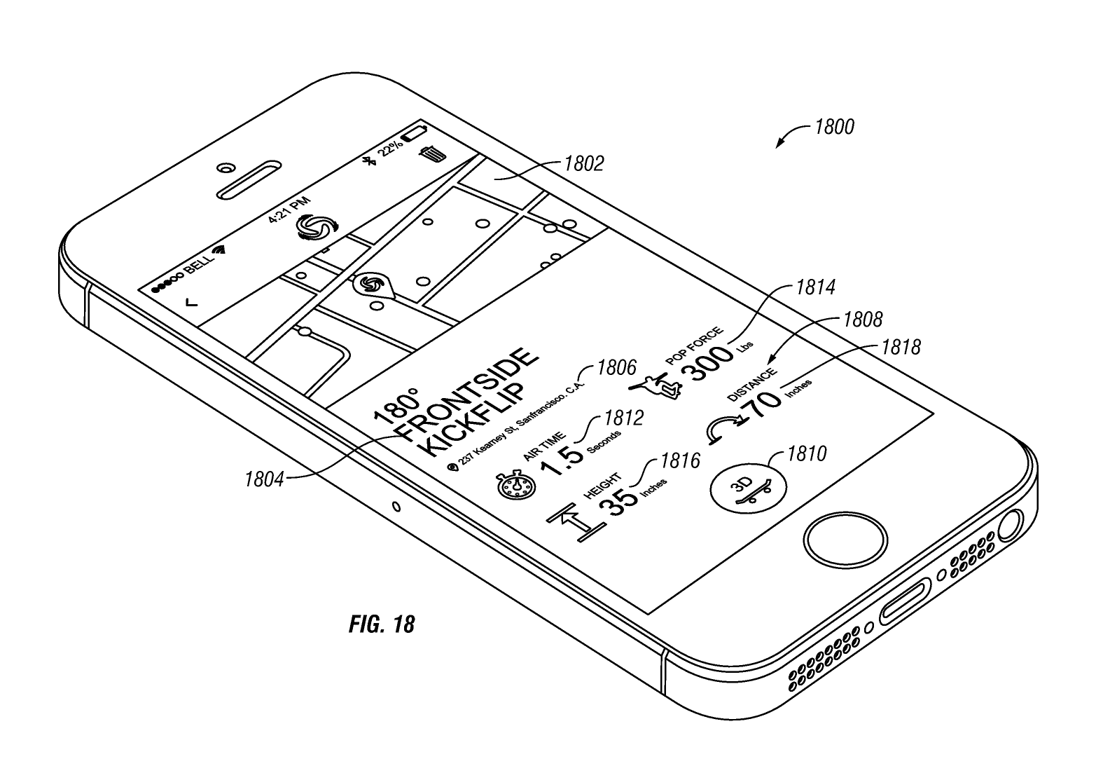

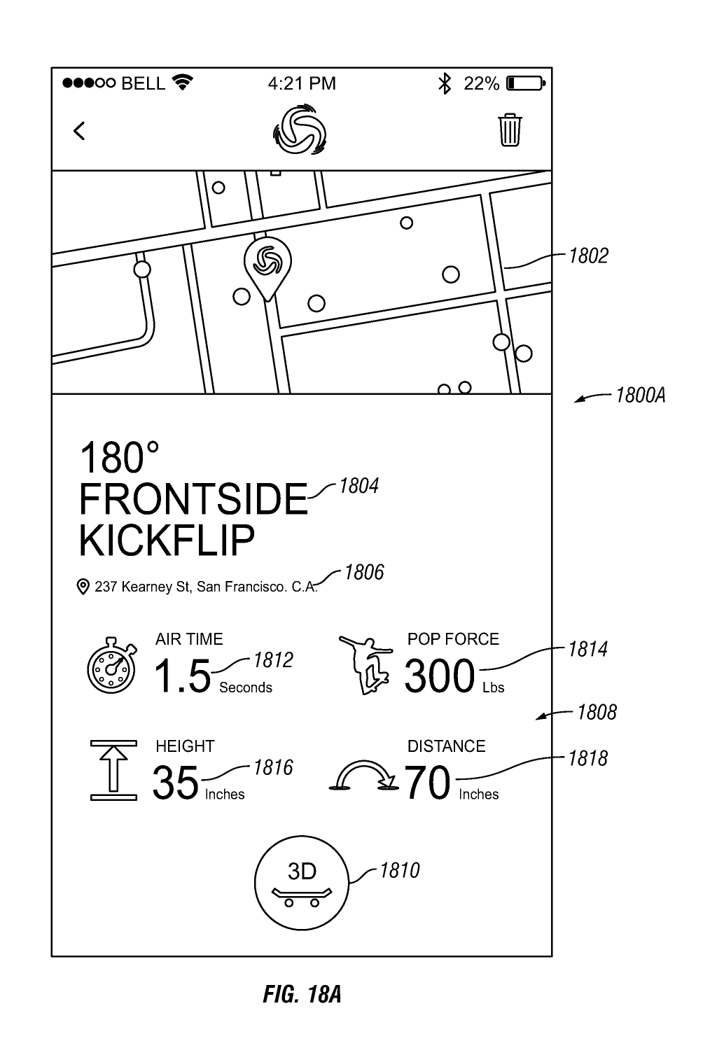

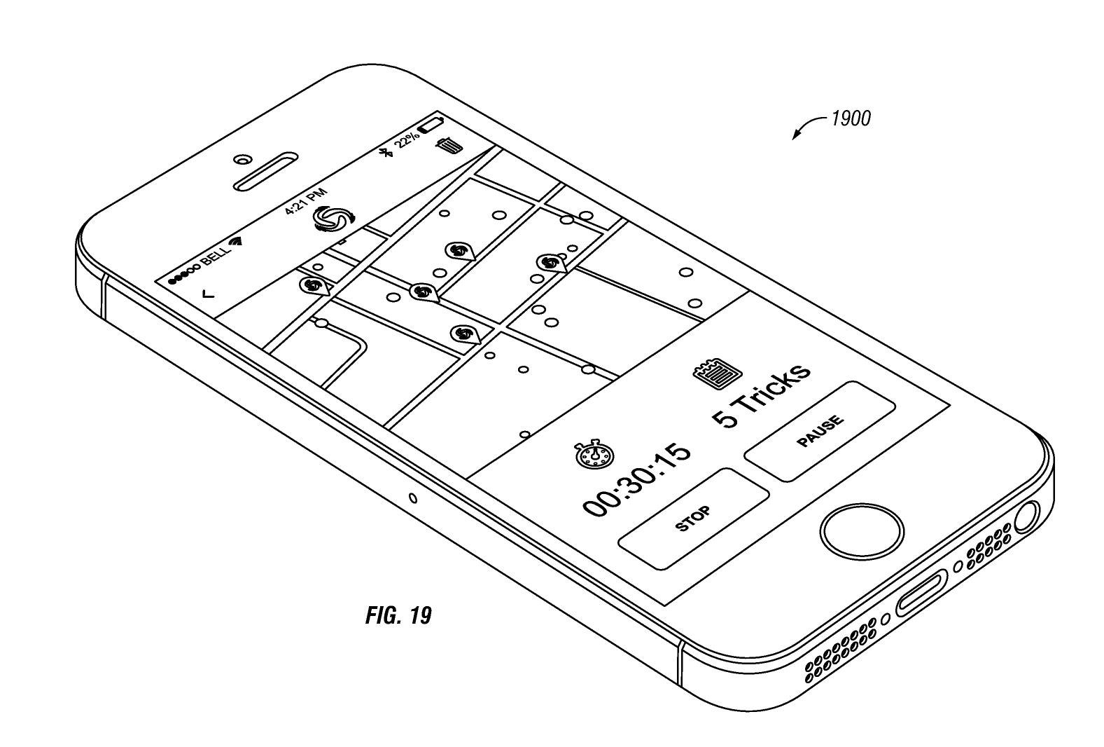

FIGS. 18 and 18A illustrate individual trick metrics displayed on a device and an individual trick display. An individual trick metrics display 1800A is shown on a user device 1800 shows one embodiment of how the individual trick metrics display 1800A can be displayed. The individual trick metrics display 1800A shows a user the graphical location 1802 where the trick was performed, the type of trick performed 1804, the street address of where the trick was performed 1806, the trick metrics display area 1808, and the button to generate a 3D rendering of the trick 1810. The trick metrics display area 1808 in this embodiment shows four trick parameters: air time 1812, pop force 1814, height 1816, and distance 1818, but can be adjusted based on user preferences.

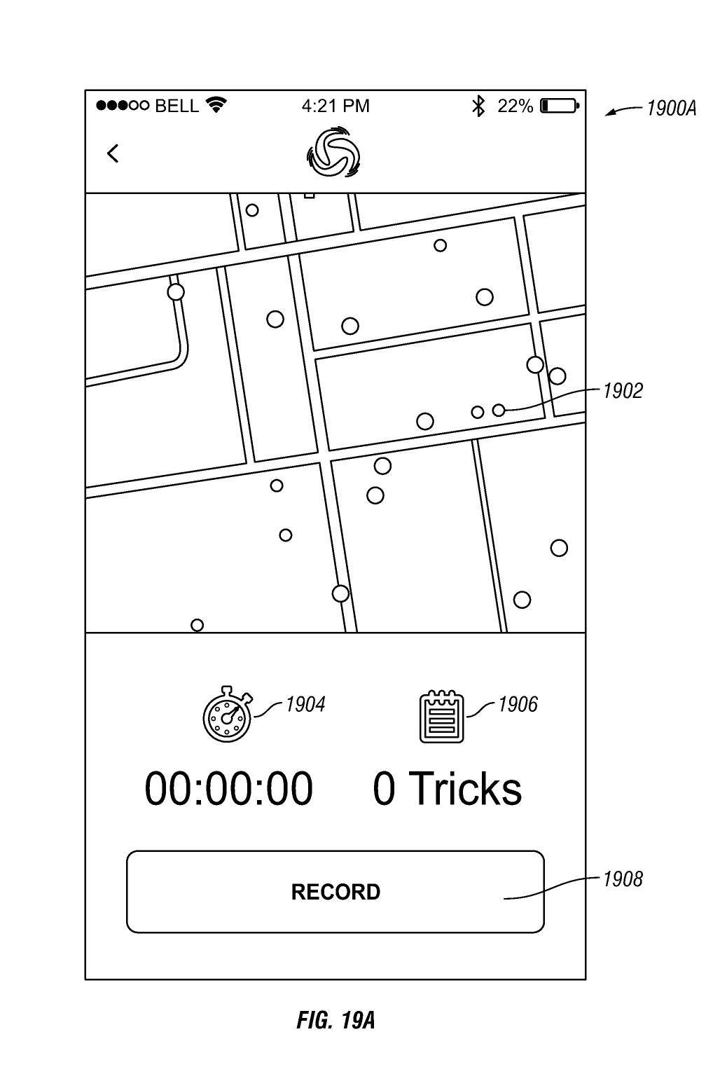

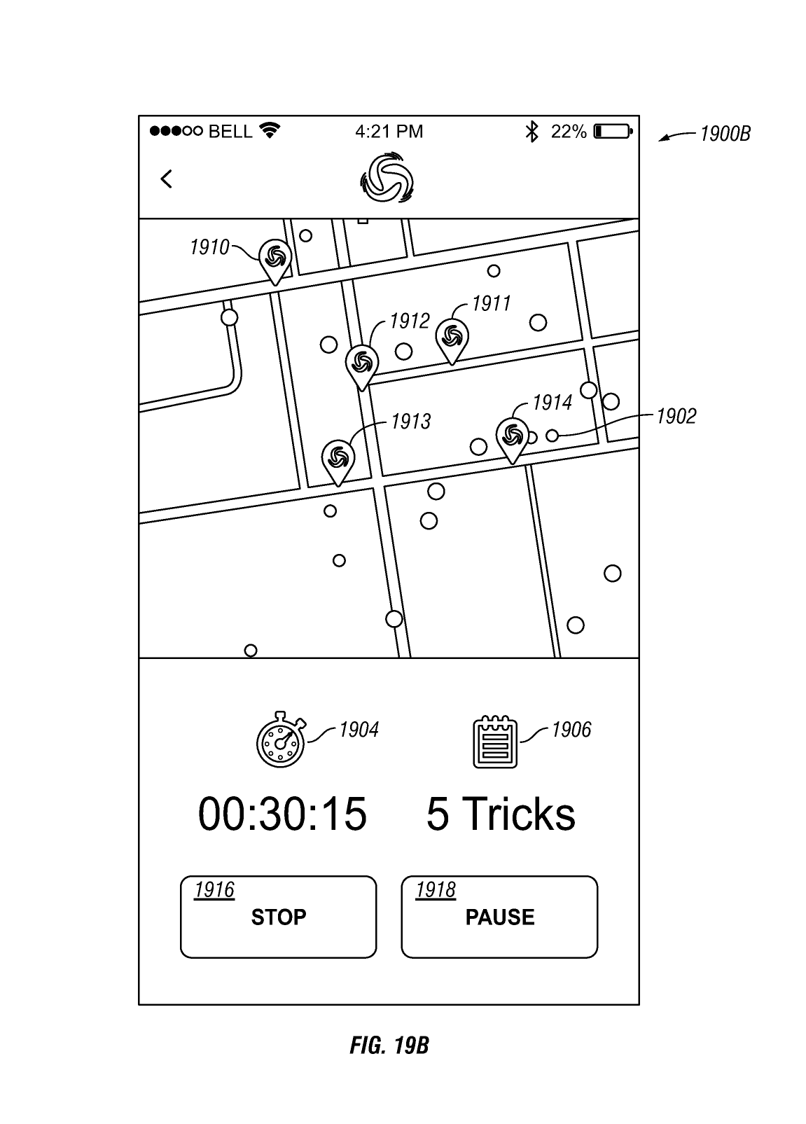

FIGS. 19, 19A and 19B illustrate the record screen with 1900 showing a recording in session on a device with 5 tricks performed thus far, 1900A shows the recording initiation screen and 1900B illustrating the record screen. The record initiation screen 1900A has a display of the current location on a map 1902, a stopwatch 1904, a trick counter 1906 with both the stopwatch 1904 and trick counter 1906 set to zero and a record button 1908. Once the record button 1908 is pressed the tracking device and the application, begin recording the path traveled with the location of each trick performed marked. During the run or session, the currently recording or recorded display 1900B shows the location of all trick performed 1910-1914 displayed on the map 1902, a stop recording button 1916, and a pause recording button 1918.

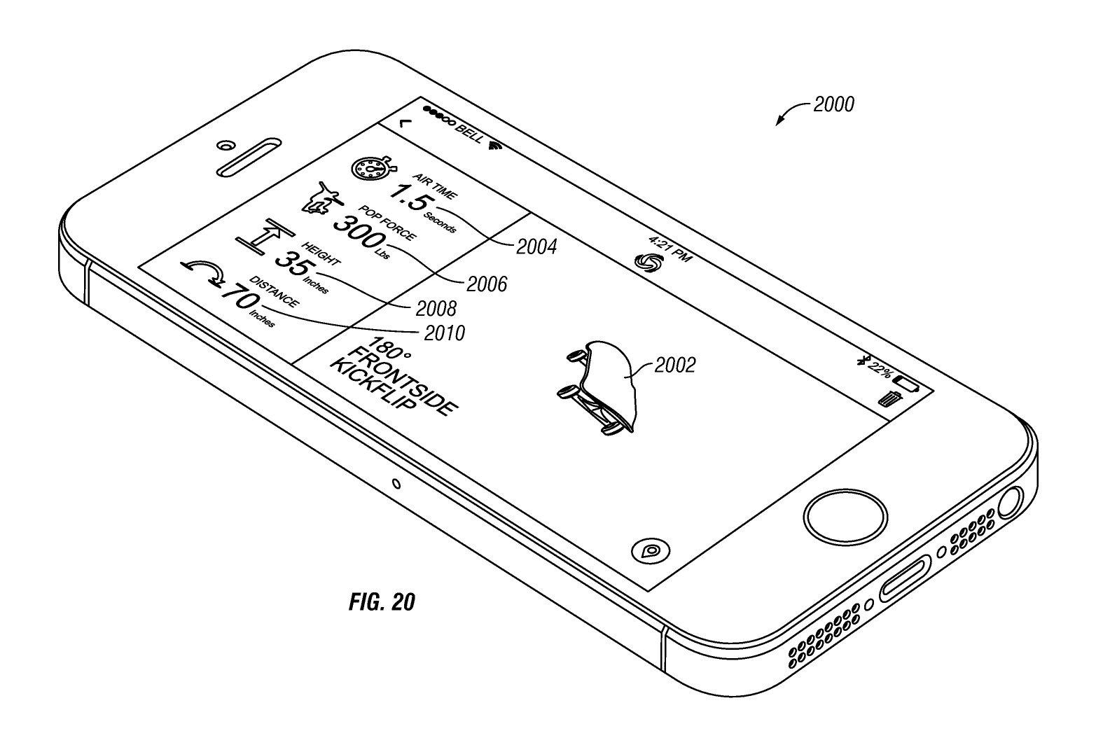

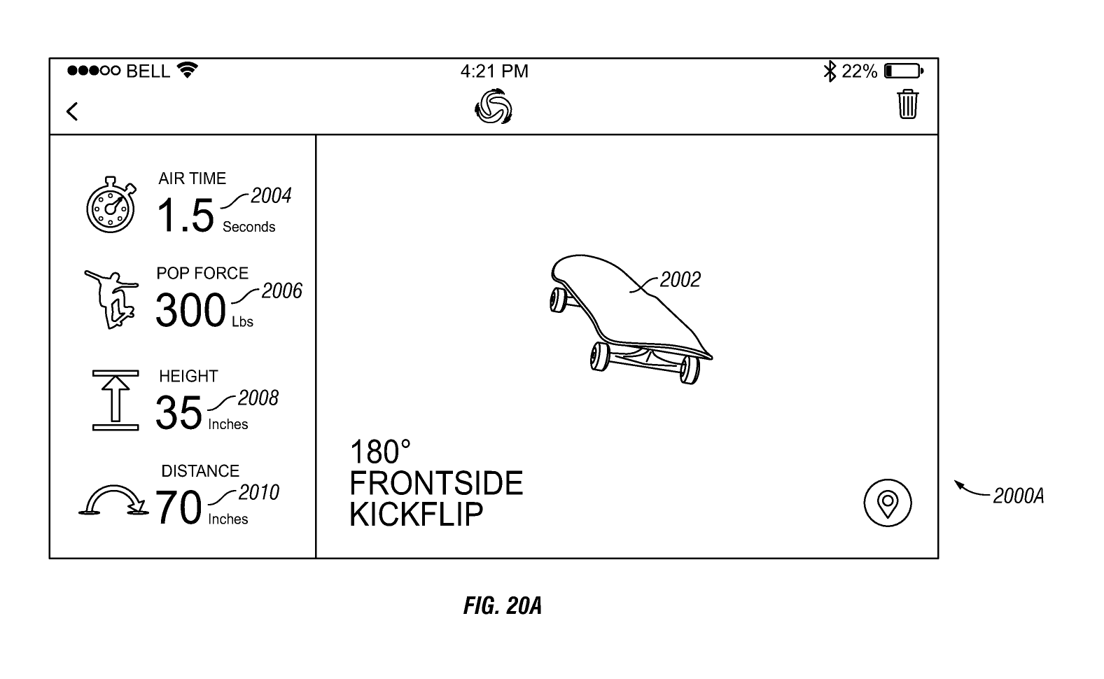

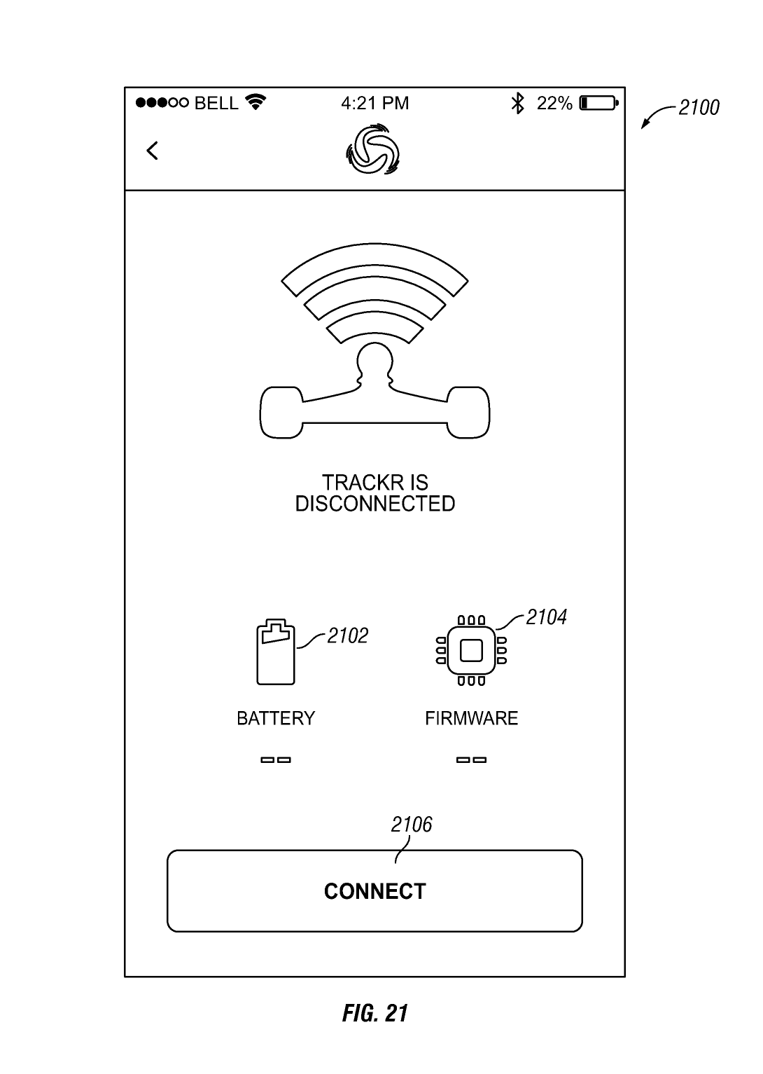

FIGS. 20 and 20A illustrate a 3D rendering of a “180 frontside kickflip” trick on a user device 2000 and the individual screen elements 2000A. The application provides different ways of replaying the board's movements during a captured trick. One of those is an animated 3D representation of the board 2002 (skateboard, surfboard, etc. having the tracking device attached thereto) that recreates the exact movement of the board, as well as the user controlling the board. For example, a 3D version of a skateboard and a skater (or surfboard and a surfer, or snowboard and a snowboarder) recreates the user's movements. This graphical video animation uses the data stream as the input and predefined movements based on the inputs to recreate the trick made by the user. The animated board moves exactly as the user's board since it uses the tracking device's sensor(s) data to create the movement. Additional trick metrics are displayed as part of the 3D rendering, including but not limited to, air time 2004, pop force 2006, height 2008 and distance 2010. These trick metrics are also used by the application and algorithms to generate the 3D rendering of the trick.

Using trick detection algorithms, the trick performed can be identified and the animated rider can be moved according to prerecorded data for those specific tricks. The data for the rider's movements may come also from extra sensors attached to the user, if desired. The 3D replay may include, but is not limited to, slow motion features, 360 degrees camera rotation, and different backgrounds, such as skate parks, ramps, stairs, street obstacles, etc.

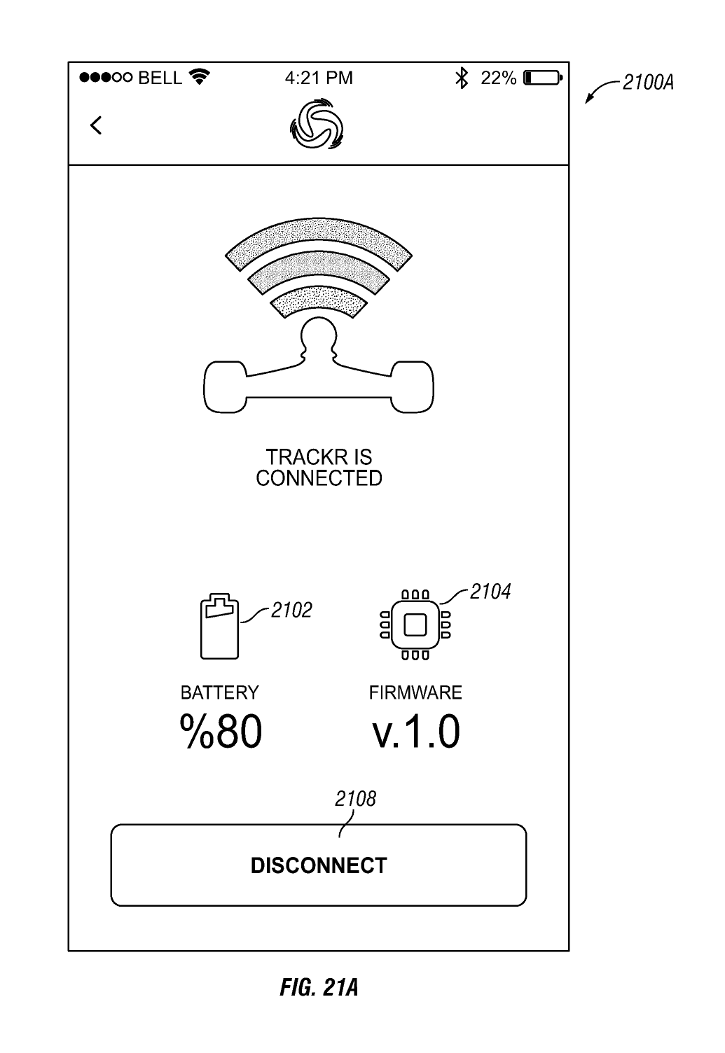

FIGS. 21 and 21A illustrate the application connection to the tracking device. When the tracker is disconnected 2100, the battery life 2102 and the firmware 2104 information are not listed and a connect button 2106 is available to initiate a connection to the tracking device. When the tracking device is connected 2100A to the application the battery life 2102 and firmware version 2104 is displayed for quick reading by a user, as well as a disconnect button 2108.

The application can also be integrated to external video recorders, such as cameras. The integration may include, but it is not limited to, smartphone cameras, action sport cameras, professional video recorders, etc. The application synchronizes the tricks detected by the algorithms with the video recorded and automatically trims the footage to match the length of the trick, as mentioned above. In cases where the external recorder is the camera of the smartphone (or other mobile device) on which the application is running, the video may be time-stamped every time a new trick is received via Bluetooth® (or any other wireless connection between the tracking device and the phone or other mobile device). When performance of the trick is finished, the video segment that corresponds to the trick is extracted (which may also include some extra seconds before and after the trick) and shown to the user. In other embodiments, the application may be integrated with a GoPro® Camera. In this case, the difference is that the application is connected on one side to the device and on the other side to the camera. The application records the stream coming from the camera and timestamps it in a similar fashion as with the smartphone camera.

The camera display or any of the trick metrics can be shared over a number of social media platforms not limited to Facebook®, Twitter®, and YouTube®. FIG. 2200 illustrates the share screen 2200, which has buttons for user preferred social media outlets 2201-2203, a written comment section 2204 and a share button 2206.

### Alternative Board Related Embodiments

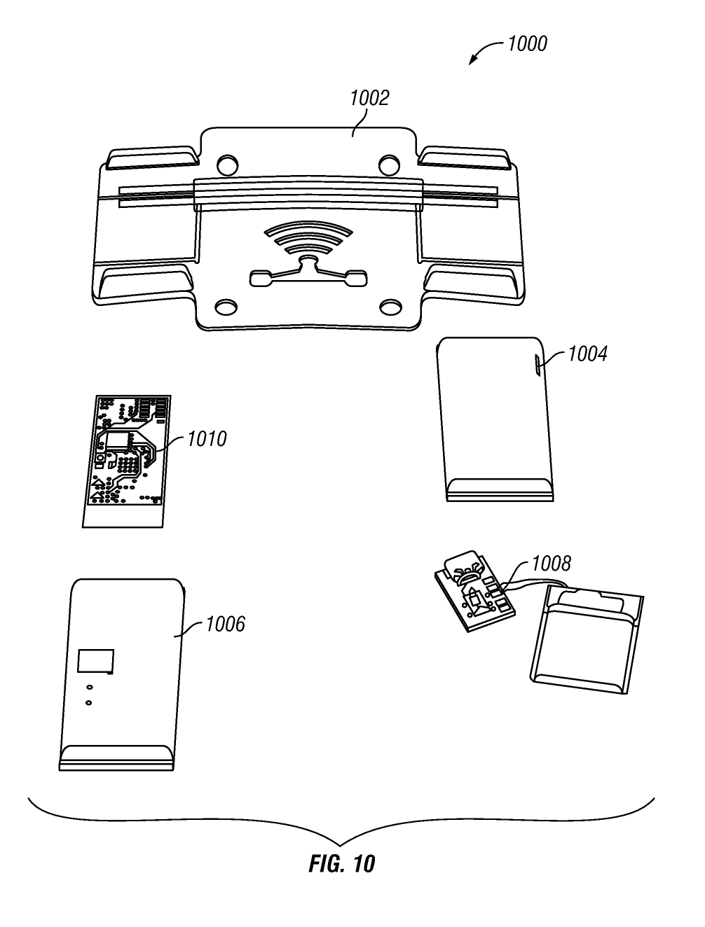

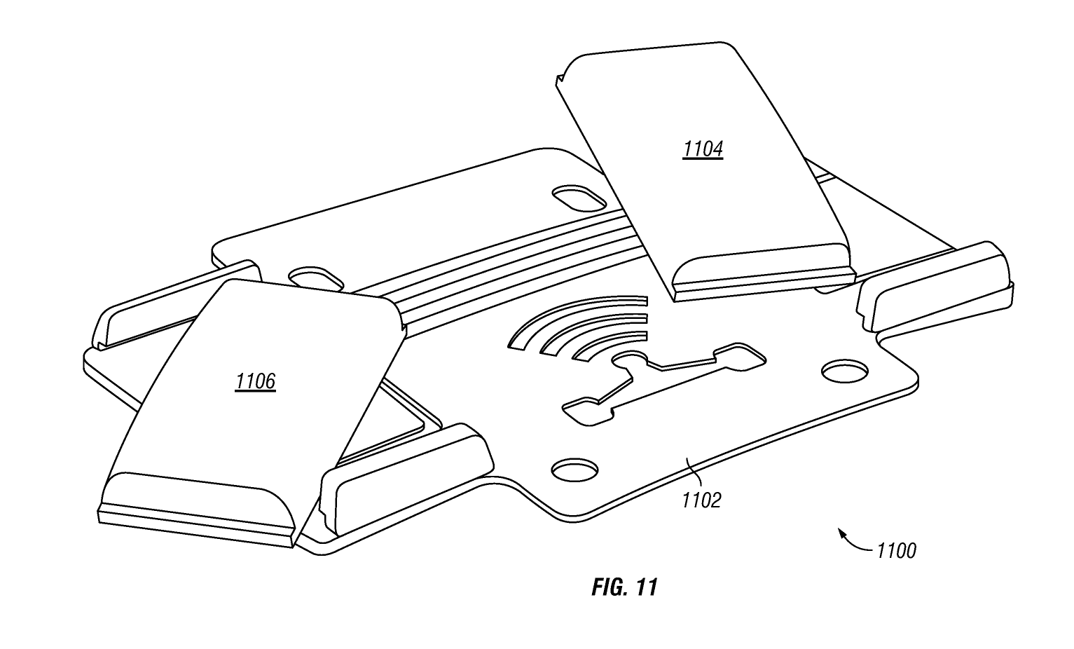

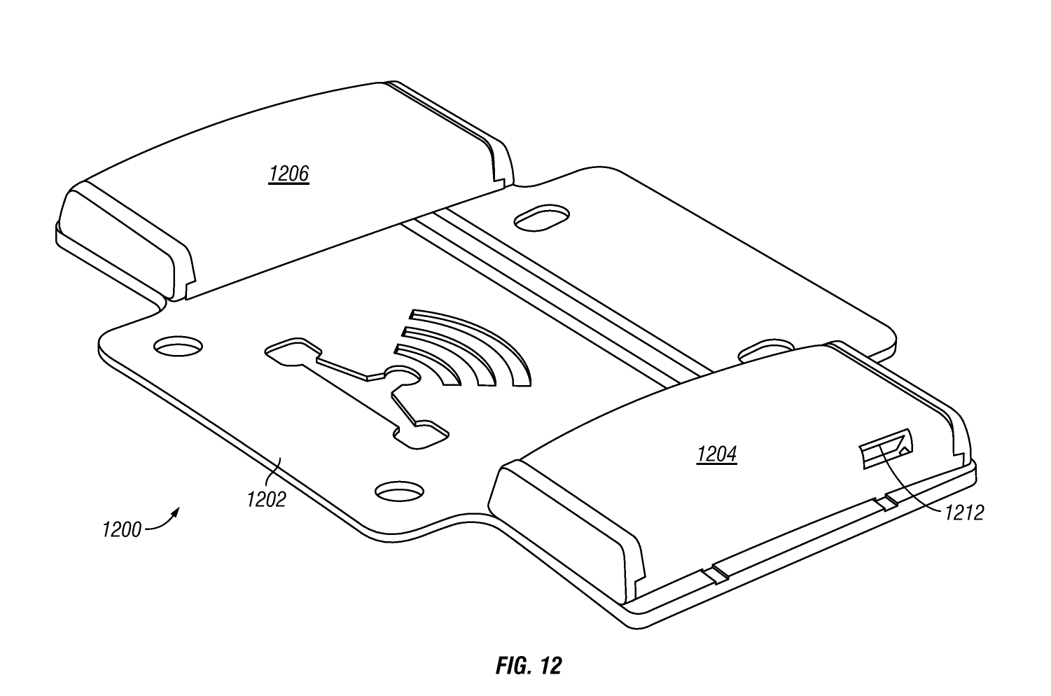

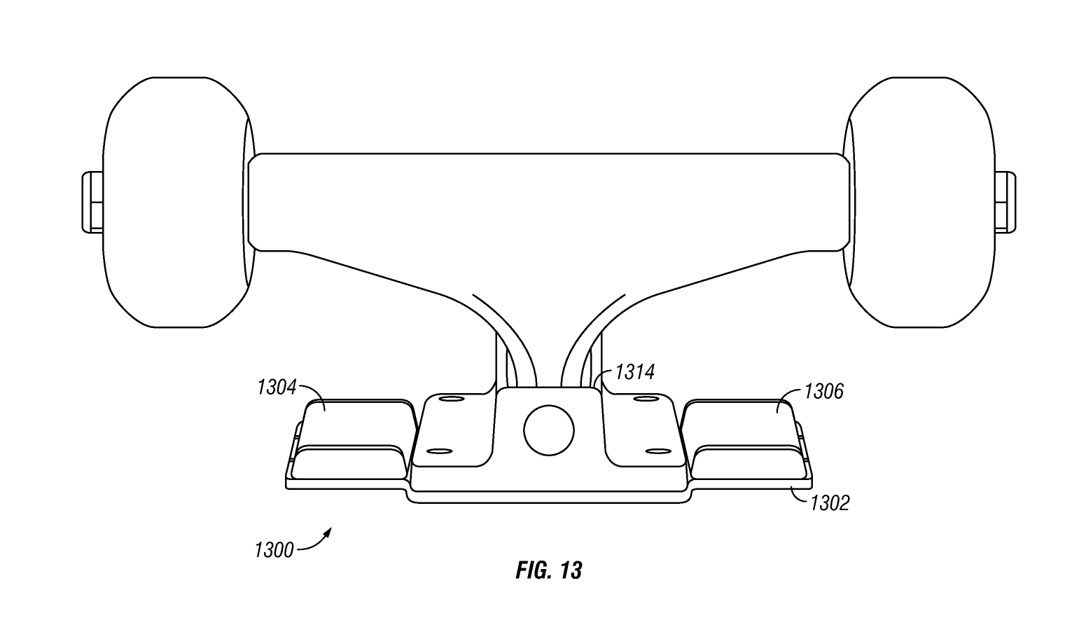

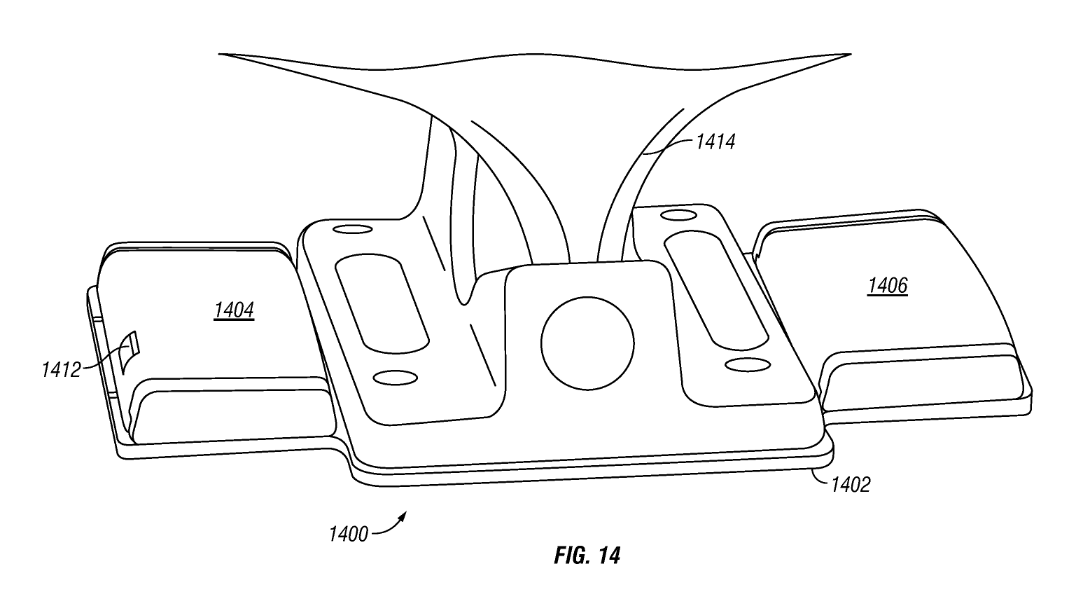

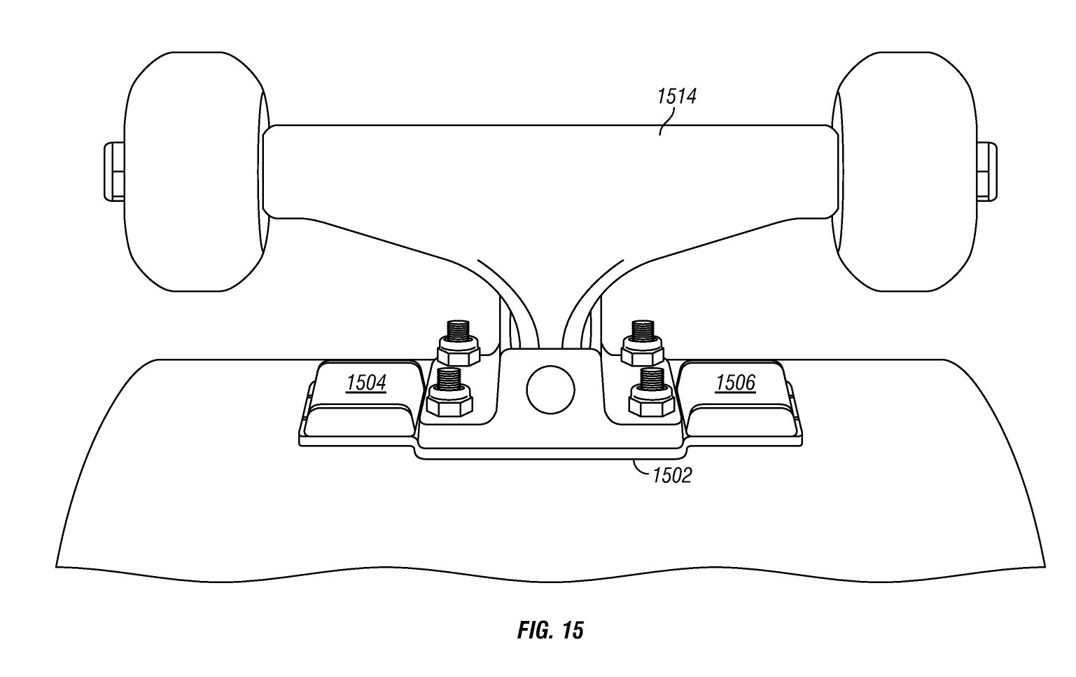

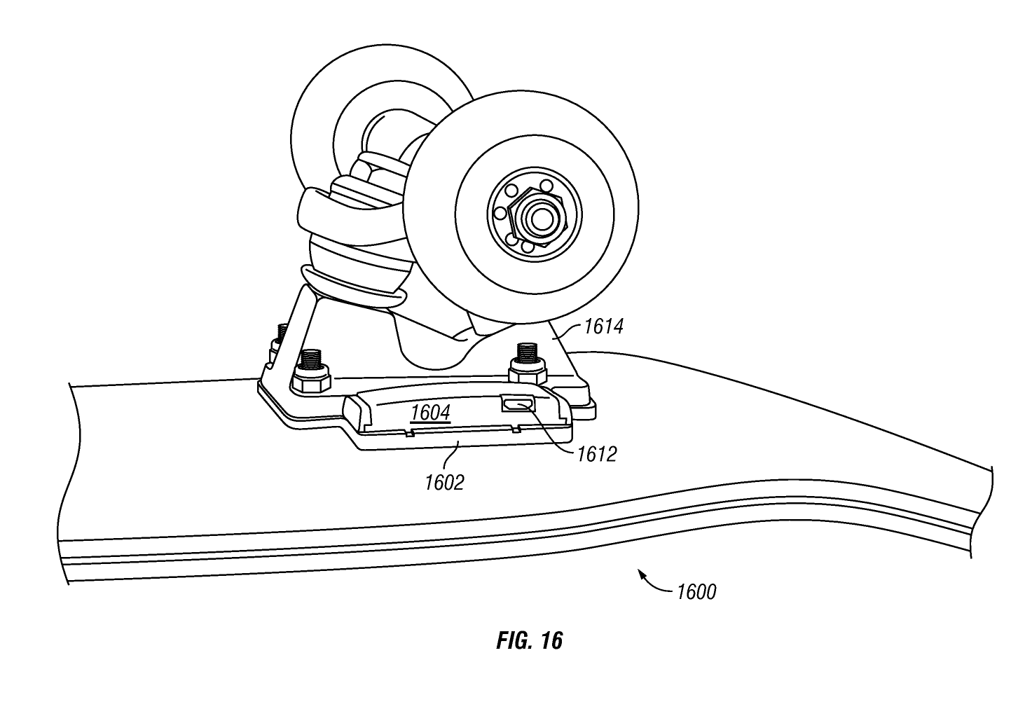

FIGS. 10-16 illustrate an alternative embodiment of the tracking device, specifically the tracking device attached to a skateboard. FIG. 10 shows the separate components of a tracking device 1000. These components include the mounting plate 1002, the mounting pads 1004 and 1006, a first electronic device 1008, and a second electronic device 1010. The electronic devices 1008 and 1010 fit into the mounting pads 1004 and 1006, and the mounting pads are attached to the mounting plate 1002 that connects to a board. FIG. 11 illustrates how the mounting pads 1104 and 1106 fit together with a mounting plate 1102. FIG. 12 illustrates the mounting pads 1204 and 1206 secured with the mounting plate 1202. The tracking device system 1200 also has a wired interface system 1212. FIG. 13 shows the tracking device 1300 attached to a truck 1314. FIG. 14 illustrates the relationship of the truck 1414 and the mounting plate 1402. The height of the mounting plate 1402 can be seen from the coin placed in front of the mounting plate 1402. This shows the lack of difference in the mounting plate 1402 and a standard riser pad. A fully attached mounting plate 1502 and be seen in FIG. 15. The system 1500 as shown does not prevent any tricks from being performed as it has a low profile, and does not interfere with operation of the truck. FIG. 16 is a side view of the system shown in FIG. 15. In this view the wired connection interface 1612 can be seen.

### Alternative Sport Embodiments

A sport tracking system in accordance with the disclosed principles is not limited to board related sports, and instead it can be used in any extreme or repetitive motion sports. An example of this would be BMX biking, similar to board sports in the performance of tricks. BMX bikers can benefit from a tracking device can record the motions of the bike and then render the trick for a user to review. An example of traditional sports would be baseball, and more specifically a baseball batter. A batter has to repeat the same motion over and over, and where even the smallest of variation can mean a strikeout verses a homerun. The tracking device can record the swing of the batter, allowing the batter to compare his swing to previous ones or others using a related social network.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A sport tracking system comprising:
at least one tracking device that includes:
a mounting subsystem for attaching the tracking device to a sport device;
a plurality of motion sensors configured to capture a sport action event involving the sport device;
a processor to create a data stream comprising the captured sport action;
a memory module for local storage of the data stream;
a communication module configured to transmit the data stream;
a power source module; and
a tracking device case to protect the tracking device;
a mobile application, executable on a mobile device, to render 3D graphic images or graphic video of the sport action from the transmitted data stream to a user of the mobile device.

2. The sport tracking system of claim 1, wherein the mobile application further comprises a sport action detection algorithm configured to recognize which sport action, selected from a collection of stored sport actions, was captured.

3. The sport tracking system of claim 1, wherein the data stream further comprises information regarding the captured sport action, the information comprising one or more of a name of the sport action, a description of the sport action, a geographic location of where the sport action occurred, a time and date of when the sport action occurred, and identification information regarding the person performing the sport action.

4. The sport tracking system of claim 3, wherein the mobile application is further configured to transmit the rendered graphic images or graphic video to a social network for sharing of the captured sport action and the information regarding the sport action.

5. The sport tracking system of claim 1, wherein the plurality of motion sensors includes one or more of an accelerometer, a gyroscope, a magnetometer, or any combination thereof.

6. The sport tracking system of claim 1, wherein the communication module includes a wired communication subsystem and a wireless communication subsystem.

7. The sport tracking system of claim 1, wherein the mobile application uses artificial intelligence (Al) or machine learning (ML) to learn the sport action for analysis against a successful comparable sport action.

8. A sport tracking device, comprising:
a mounting system for attaching the tracking device to a sport device;
a plurality of sensors configured to capture a sport action event involving the sport device;
a processor to create a data stream comprising the captured sport action;
a memory module for local storage of the data stream;
a communication module configured to transmit the data stream;
a power source module; and
a tracking device case to protect the tracking device.

9. The sport tracking device of claim 8, wherein the data stream is configured for use to generate a 3D rendering of the captured sport action.

10. The sport tracking device of claim 8, wherein the data stream further comprises information regarding the captured sport action, wherein the information regarding the captured sport action comprises one or more of a name of the sport action, a description of the sport action, a geographic location of where the sport action occurred, a time and date of when the sport action occurred, and identification information regarding the person performing the sport action.

11. The sport tracking device of claim 8, wherein the plurality of motion sensors includes one or more of an accelerometer, a gyroscope, a magnetometer, or any combination thereof.

12. The sport tracking device of claim 8, wherein the communication module includes a wired communication subsystem and a wireless communication subsystem.

13. A method of tracking a sport action event, comprising the steps of:
capturing motion data of a sport device during a sport action using a plurality of motion sensors housed within a tracking device attached to a sport device;
creating a data stream comprising the sport action from the captured motion data using a processor housed within the tracking device;
storing the data stream in a memory module housed within the tracking device;
transmitting the data stream from tracking device to an application, executed on a computing device, using a communication module housed in the tracking device;
reading the data stream received at the computing device with the application; and
generating a 3D graphic image or graphic video of the sport action from the data stream using the application, the generated 3D graphic image or graphic video displayable on the computing device.

14. The method of claim 13, wherein capturing motion data comprises detecting the sport action through measuring a threshold of the output curves, an abrupt change in the output curves, or wavelet integrals using the motion sensors.

15. The method of claim 13, wherein the data stream further comprises information regarding the captured sport action, the information comprising one or more of a name of the sport action, a description of the sport action, a geographic location of where the sport action occurred, a time and date of when the sport action occurred, and identification information regarding the person performing the sport action.

16. The method of claim 15, further comprising transmitting the generated graphic image or graphic video to a social network for sharing of the captured sport action and the information regarding the sport action.

17. The method of claim 13, further comprising detecting which sport action, selected from a collection of stored sport actions, was captured using a sport action detection algorithm.

18. The method of claim 17, further comprising comparing one or more elements of the captured sport action to corresponding elements of a stored successful comparable sport action, and generating a score for the captured sport action based on the comparison.

19. The method of claim 18, wherein the detecting and comparing are accomplished using an artificial intelligence (Al) algorithm, a neural network, a support vector machine (SVM) or a machine learning (ML) algorithm.

20. The method of claim 18, further comprising displaying on the computing device preferred metrics of one or more scored elements of the successful comparable sport action not detected in the captured sport action.
